(19) United States
(12) Patent Application Publication
(10) Pub. No.: US 2026/0304333 A1
(43) Pub. Date: Oct. 1, 2026

(54) METHOD AND APPARATUS FOR TRANSMITTING AND RECEIVING ON-DEMAND SYNCHRONIZATION SIGNAL IN WIRELESS COMMUNICATION

(71) Applicant: KT CORPORATION, Gyeonggi-do (KR)

(72) Inventor: Ki Hyeon PARK, Gyeonggi-do (KR)

(73) Assignee: KT CORPORATION, Gyeonggi-do (KR)

(21) Appl. No.: 19/578,821

(22) Filed: Mar. 25, 2026

(30) Foreign Application Priority Data
Mar. 25, 2025 (KR) 10-2025-0038372
Mar. 23, 2026 (KR) 10-2026-0052235

(51) Int. Cl. H04W 56/00

(52) U.S. Cl. CPC H04W 56/0015

(57) ABSTRACT

Provided is a method for receiving an On-Demand Synchronization Signal Block (OD-SSB) by a UE in wireless communication. The method may include: receiving, from a base station, a higher layer message comprising configuration information for the OD-SSB; receiving, from the base station, a first MAC-CE indicating activation of the OD-SSB; and receiving the OD-SSB based on the configuration information and the first MAC-CE, wherein the receiving of the OD-SSB is performed based on whether a parameter related to a number of transmissions of the OD-SSB is included in the configuration information.

### CROSS-REFERENCE TO RELATED APPLICATIONS

This application claims priority from Korean Patent Application Nos. 10-2025-0038372, filed on 2025 Mar. 25 and 10-2026-0052235, filed on 2026 Mar. 23, which are hereby incorporated by reference for all purposes as if fully set forth herein.

### BACKGROUND

### Field

The present disclosure proposes a method and an apparatus for transmitting and receiving an on-demand synchronization signal in a radio access network (“5G”, “NR[New Radio]”) or a next-generation radio access network (referring to “5G-Advanced”, “6G”, or a subsequent 3GPP radio access network).

### Description of Related Art

3GPP continues research and development on wireless communication technologies. In wireless communication systems, energy efficiency of the network is a very important consideration in addition to latency, stability, and availability.

A base station must transmit predetermined system information along with transmission of a synchronization signal for access of a UE. In the related art, such an operation is performed periodically regardless of the number of UEs capable of accessing a network, and accordingly, unnecessary power consumption occurred even in an idle situation where the number of UEs capable of accessing is small.

Therefore, there is a demand for designing a specific procedure and control method for enabling more efficient transmission and reception of a synchronization signal and system information for power saving.

### SUMMARY

The present disclosure provides a method and an apparatus for transmitting and receiving an on-demand synchronization signal in wireless communication.

In accordance with an embodiment, a method of a UE may be provided for receiving an On-Demand Synchronization Signal Block (OD-SSB) in wireless communication. The method may include: receiving, from a base station, a higher layer message comprising configuration information for the OD-SSB; receiving, from the base station, a first Medium Access Control-Control Element (MAC-CE) indicating activation of the OD-SSB; and receiving the OD-SSB based on the configuration information and the first MAC-CE, wherein the receiving of the OD-SSB is performed based on whether a parameter related to a number of transmissions of the OD-SSB is included in the configuration information.

In accordance with another embodiment, a method of a base station may be provided for transmitting an On-Demand Synchronization Signal Block (OD-SSB) in wireless communication. The method may include: transmitting, to a UE, a higher layer message comprising configuration information for the OD-SSB; transmitting, to the UE, a first Medium Access Control-Control Element (MAC-CE) indicating activation of the OD-SSB; and transmitting the OD-SSB based on the configuration information and the first MAC-CE, wherein the transmitting of the OD-SSB is performed based on whether a parameter related to a number of transmissions of the OD-SSB is included in the configuration information.

In accordance with further another embodiment, a UE may be provided for receiving an on-demand synchronization signal in wireless communication. The UE may include: a transmitter; a receiver; and a controller configured to control operations of the transmitter and the receiver, wherein the controller is configured to: receive, from a base station, a higher layer message comprising configuration information for an OD-SSB; receive, from the base station, a first Medium Access Control-Control Element (MAC-CE) indicating activation of the OD-SSB; and receive the OD-SSB based on the configuration information and the first MAC-CE, and wherein the receiving of the OD-SSB is performed based on whether a parameter related to a number of transmissions of the OD-SSB is included in the configuration information.

In accordance with still another embodiment, a base station may be provided for transmitting an on-demand synchronization signal in wireless communication. The base station may include: a transmitter; a receiver; and a controller configured to control operations of the transmitter and the receiver, wherein the controller is configured to: transmit, to a UE, a higher layer message comprising configuration information for an OD-SSB; transmit, to the UE, a first Medium Access Control-Control Element (MAC-CE) indicating activation of the OD-SSB; and transmit the OD-SSB based on the configuration information and the first MAC-CE, and wherein the transmitting of the OD-SSB is performed based on whether a parameter related to a number of transmissions of the OD-SSB is included in the configuration information.

According to the embodiments, an On-Demand Synchronization Signal Block (OD-SSB) and system information may be efficiently transmitted and received in wireless communication.

In addition, efficient synchronization signal transmission management may be supported in an environment in which a base station operates an On-Demand SSB.

### BRIEF DESCRIPTION OF THE DRAWINGS

The above and other objects, features, and advantages of the disclosure will be more clearly understood from the following detailed description, taken in conjunction with the accompanying drawings, in which:

FIG. 1 is a diagram briefly illustrating a structure of an NR wireless communication system to which the present embodiment may be applied;

FIG. 2 is a diagram for explaining a frame structure in an NR system to which the present embodiment may be applied;

FIG. 3 is a diagram for explaining a resource grid supported by a wireless access technology to which the present embodiment may be applied;

FIG. 4 is a diagram for explaining a bandwidth part supported by a wireless access technology to which the present embodiment may be applied;

FIG. 5 is a diagram exemplarily illustrating a synchronization signal block in a wireless access technology to which the present embodiment may be applied;

FIG. 6 is a diagram for explaining a random access procedure in a wireless access technology to which the present embodiment may be applied;

FIG. 7 is a diagram for explaining a CORESET;

FIG. 8 is a diagram illustrating a procedure for a UE to receive an On-Demand Synchronization Signal Block (OD-SSB) in wireless communication according to an embodiment;

FIG. 9 is a diagram illustrating a procedure for a base station to transmit an On-Demand Synchronization Signal Block (OD-SSB) in wireless communication according to an embodiment;

FIG. 10 is a diagram showing a configuration of a UE according to another embodiment;

FIG. 11 is a diagram showing a configuration of a base station according to another embodiment.

### DETAILED DESCRIPTION

Hereinafter, some embodiments of the present disclosure will be described in detail with reference to the accompanying illustrative drawings. In the drawings, like reference numerals are used to denote like elements throughout the drawings, even if they are shown on different drawings. Further, in the following description of the present disclosure, a detailed description of known functions and configurations incorporated herein will be omitted when it may make the subject matter of the present disclosure rather unclear. When the expression “include”, “have”, “comprise”, or the like as mentioned herein is used, any other part may be added unless the expression “only” is used. When an element is expressed in the singular, the element may cover the plural form unless a special mention is explicitly made of the element.

In addition, terms, such as first, second, A, B, (A), (B) or the like may be used herein when describing components of the present disclosure. Each of these terminologies is not used to define an essence, order or sequence of a corresponding component but used merely to distinguish the corresponding component from other component(s).

In describing the positional relationship between components, if two or more components are described as being “connected”, “combined”, or “coupled” to each other, it should be understood that two or more components may be directly “connected”, “combined”, or “coupled” to each other, and that two or more components may be “connected”, “combined”, or “coupled” to each other with another component “interposed” therebetween. In this case, another component may be included in at least one of the two or more components that are “connected”, “combined”, or “coupled” to each other.

In the description of a sequence of operating methods or manufacturing methods, for example, the expressions using “after”, “subsequent to”, “next”, “before”, and the like may also encompass the case in which operations or processes are performed discontinuously unless “immediately” or “directly” is used in the expression.

Numerical values for components or information corresponding thereto (e.g., levels or the like), which are mentioned herein, may be interpreted as including an error range caused by various factors (e.g., process factors, internal or external impacts, noise, etc.) even if an explicit description thereof is not provided.

The wireless communication system in the present specification refers to a system for providing various communication services, such as a voice service and a data service, using radio resources. The wireless communication system may include a user equipment (UE), a base station, a core network, and the like.

Embodiments disclosed below may be applied to a wireless communication system using various radio access technologies. For example, the embodiments may be applied to various radio access technologies such as code division multiple access (CDMA), frequency division multiple access (FDMA), time division multiple access (TDMA), orthogonal frequency division multiple access (OFDMA), single-carrier frequency division multiple access (SC-FDMA), non-orthogonal multiple access (NOMA), or the like. In addition, the radio access technology may refer to respective generation communication technologies established by various communication organizations, such as 3GPP, 3GPP2, WiFi, Bluetooth, IEEE, ITU, or the like, as well as a specific access technology. For example, CDMA may be implemented as a wireless technology such as universal terrestrial radio access (UTRA) or CDMA2000. TDMA may be implemented as a wireless technology such as global system for mobile communications (GSM)/general packet radio service (GPRS)/enhanced data rates for GSM evolution (EDGE). OFDMA may be implemented as a wireless technology such as IEEE (Institute of Electrical and Electronics Engineers) 802.11 (Wi-Fi), IEEE 802.16 (WiMAX), IEEE 802-20, evolved UTRA (E-UTRA), and the like. IEEE 802.16m is evolution of IEEE 802.16e, which provides backward compatibility with systems based on IEEE 802.16e. UTRA is a part of a universal mobile telecommunications system (UMTS). 3GPP (3rd-generation partnership project) LTE (long-term evolution) is a part of E-UMTS (evolved UMTS) using evolved-UMTS terrestrial radio access (E-UTRA), which adopts OFDMA in a downlink and SC-FDMA in an uplink. As described above, the embodiments may be applied to radio access technologies that have been launched or commercialized, and may be applied to radio access technologies that are being developed or will be developed in the future.

The UE used in the specification must be interpreted as a broad meaning that indicates a device including a wireless communication module that communicates with a base station in a wireless communication system. For example, the UE includes user equipment (UE) in WCDMA, LTE, NR, HSPA, IMT-2020 (5G or New Radio), and the like, a mobile station in GSM, a user terminal (UT), a subscriber station (SS), a wireless device, and the like. In addition, the UE may be a portable user device, such as a smart phone, or may be a vehicle, a device including a wireless communication module in the vehicle, and the like in a V2X communication system according to the usage type thereof. In the case of a machine-type communication (MTC) system, the UE may refer to an MTC terminal, an M2M terminal, or a URLLC terminal, which employs a communication module capable of performing machine-type communication.

A base station or a cell in the present specification refers to an end that communicates with a UE through a network and encompasses various coverage regions such as a Node-B, an evolved Node-B (eNB), a gNode-B, a low-power node (LPN), a sector, a site, various types of antennas, a base transceiver system (BTS), an access point, a point (e.g., a transmission point, a reception point, or a transmission/reception point), a relay node, a megacell, a macrocell, a microcell, a picocell, a femtocell, a remote radio head (RRH), a radio unit (RU), a small cell, and the like. In addition, the cell may be used as a meaning including a bandwidth part (BWP) in the frequency domain. For example, the serving cell may refer to an active BWP of a UE.

The various cells listed above are provided with a base station controlling one or more cells, and the base station may be interpreted as two meanings. The base station may be 1) a device for providing a megacell, a macrocell, a microcell, a picocell, a femtocell, or a small cell in connection with a wireless region, or the base station may be 2) a wireless region itself. In the above description 1), the base station may be the devices controlled by the same entity and providing predetermined wireless regions or all devices interacting with each other and cooperatively configuring a wireless region. For example, the base station may be a point, a transmission/reception point, a transmission point, a reception point, and the like according to the configuration method of the wireless region. In the above description 2), the base station may be the wireless region in which a user equipment (UE) may be enabled to transmit data to and receive data from the other UE or a neighboring base station.

In this specification, the cell may refer to coverage of a signal transmitted from a transmission/reception point, a component carrier having coverage of a signal transmitted from a transmission/reception point (or a transmission point), or a transmission/reception point itself.

An uplink (UL) refers to a scheme of transmitting data from a UE to a base station, and a downlink (DL) refers to a scheme of transmitting data from a base station to a UE. The downlink may mean communication or communication paths from multiple transmission/reception points to a UE, and the uplink may mean communication or communication paths from a UE to multiple transmission/reception points. In the downlink, a transmitter may be a part of the multiple transmission/reception points, and a receiver may be a part of the UE. In addition, in the uplink, the transmitter may be a part of the UE, and the receiver may be a part of the multiple transmission/reception points.

The uplink and downlink transmit and receive control information over a control channel, such as a physical downlink control channel (PDCCH) and a physical uplink control channel (PUCCH). The uplink and downlink transmit and receive data over a data channel such as a physical downlink shared channel (PDSCH) and a physical uplink shared channel (PUSCH). Hereinafter, the transmission and reception of a signal over a channel, such as PUCCH, PUSCH, PDCCH, PDSCH, or the like, may be expressed as “PUCCH, PUSCH, PDCCH, PDSCH, or the like is transmitted and received”.

For the sake of clarity, the following description will focus on 3GPP LTE/LTE-A/NR (New Radio) communication systems, but technical features of the disclosure are not limited to the corresponding communication systems.

The 3GPP has been developing a 5G (5th-Generation) communication technology in order to meet the requirements of a next-generation radio access technology of ITU-R after studying 4G (4th-generation) communication technology. Specifically, 3GPP is developing, as a 5G communication technology, LTE-A pro by improving the LTE-Advanced technology so as to conform to the requirements of ITU-R and a new NR communication technology that is totally different from 4G communication technology. LTE-A pro and NR all refer to the 5G communication technology. Hereinafter, the 5G communication technology will be described on the basis of NR unless a specific communication technology is specified.

Various operating scenarios have been defined in NR in consideration of satellites, automobiles, new verticals, and the like in the typical 4G LTE scenarios so as to support an enhanced mobile broadband (eMBB) scenario in terms of services, a massive machine-type communication (mMTC) scenario in which UEs spread over a broad region at a high UE density, thereby requiring low data rates and asynchronous connections, and an ultra-reliability and low-latency (URLLC) scenario that requires high responsiveness and reliability and supports high-speed mobility.

In order to satisfy such scenarios, NR introduces a wireless communication system employing a new waveform and frame structure technology, a low-latency technology, a super-high frequency band (mmWave) support technology, and a forward compatible provision technology. In particular, NR system has various technological changes in terms of flexibility in order to provide forward compatibility. The primary technical features of NR will be described below with reference to the drawings.

### <Overview of NR System>

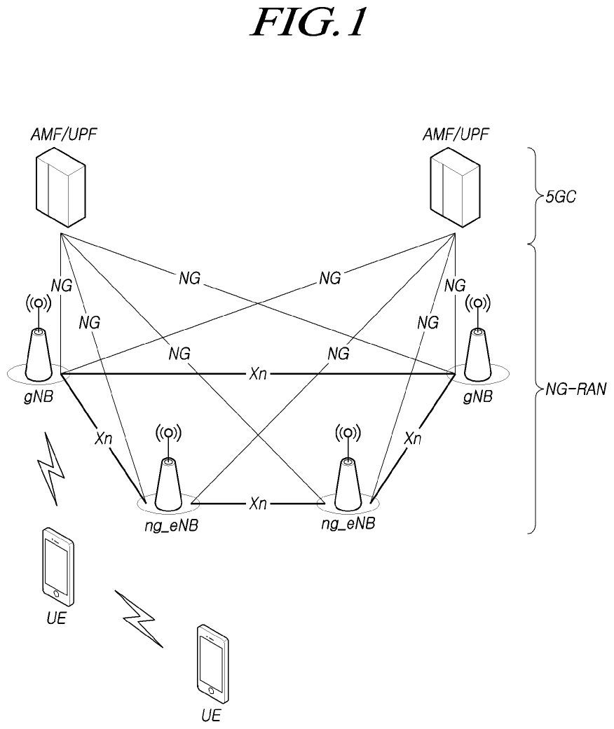

FIG. 1 is a view schematically illustrating an NR system to which the present embodiment is applicable.

Referring to FIG. 1, NR system is divided into a 5G core network (5GC) and an NG-RAN part. The NG-RAN includes gNBs and ng-eNBs providing user plane (SDAP/PDCP/RLC/MAC/PHY) and user equipment (UE) control plane (RRC) protocol ends. The gNBs or the gNB and the ng-eNB are connected to each other through Xn interfaces. The gNB and the ng-eNB are connected to the 5GC through NG interfaces, respectively. The 5GC may be configured to include an access and mobility management function (AMF) for managing a control plane, such as a UE connection and mobility control function, and a user plane function (UPF) controlling user data. NR supports both frequency bands below 6 GHz (frequency range 1 FR1 FR1) and frequency bands equal to or greater than 6 GHz (frequency range 2 FR2 FR2).

The gNB denotes a base station that provides a UE with an NR user plane and control plane protocol end. The ng-eNB denotes a base station that provides a UE with an E-UTRA user plane and control plane protocol end. The base station described in the present specification should be understood as encompassing the gNB and the ng-eNB. However, the base station may be also used to refer to the gNB or the ng-eNB separately from each other, as necessary.

### <NR Waveform, Numerology, and Frame Structure>

NR uses a CP-OFDM waveform using a cyclic prefix for downlink transmission and uses CP-OFDM or DFT-s-OFDM for uplink transmission. OFDM technology is easy to combine with a multiple-input multiple-output (MIMO) scheme and allows a low-complexity receiver to be used with high frequency efficiency.

Since the three scenarios described above have different requirements for data rates, delay rates, coverage, and the like from each other in NR, it is necessary to efficiently satisfy the requirements for each scenario over frequency bands constituting NR system. To this end, a technique for efficiently multiplexing radio resources based on a plurality of different numerologies has been proposed.

Specifically, NR transmission numerology is determined on the basis of subcarrier spacing and a cyclic prefix (CP). As shown in Table 1 below, “μ” is used as an exponential value of 2 so as to be changed exponentially on the basis of 15 kHz.

TABLE 1

| | Subcarrier | | Supported | Supported |
|---|---|---|---|---|
| μ | spacing | Cyclic prefix | for data | for synch |
| 0 | 15 | normal | Yes | Yes |
| 1 | 30 | normal | Yes | Yes |
| 2 | 60 | Normal, Extended | Yes | No |
| 3 | 120 | normal | Yes | Yes |
| 4 | 240 | normal | No | Yes |

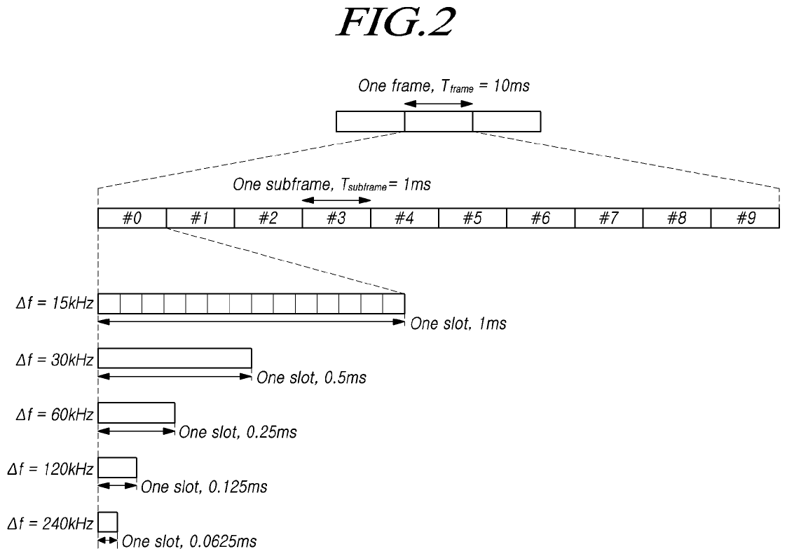

As shown in Table 1 above, NR may have five types of numerologies according to subcarrier spacing. This is different from LTE, which is one of the 4G-communication technologies, in which the subcarrier spacing is fixed to 15 kHz. Specifically, in NR, subcarrier spacing used for data transmission is 15, 30, 60, or 120 kHz, and subcarrier spacing used for synchronization signal transmission is 15, 30, 120, or 240 kHz. In addition, an extended CP is applied only to the subcarrier spacing of 60 kHz. A frame that includes 10 subframes each having the same length of 1 ms and has a length of 10 ms is defined in the frame structure in NR. One frame may be divided into half frames of 5 ms, and each half frame includes 5 subframes. In the case of a subcarrier spacing of 15 kHz, one subframe includes one slot, and each slot includes 14 OFDM symbols. FIG. 2 is a view for explaining a frame structure in an NR system to which the present embodiment may be applied.

Referring to FIG. 2, a slot includes 14 OFDM symbols, which are fixed, in the case of a normal CP, but the length of the slot in the time domain may be varied depending on subcarrier spacing. For example, in the case of a numerology having a subcarrier spacing of 15 kHz, the slot is configured to have the same length of 1 ms as that of the subframe. On the other hand, in the case of a numerology having a subcarrier spacing of 30 kHz, the slot includes 14 OFDM symbols, but one subframe may include two slots each having a length of 0.5 ms. That is, the subframe and the frame may be defined using a fixed time length, and the slot may be defined as the number of symbols such that the time length thereof is varied depending on the subcarrier spacing.

NR defines a basic unit of scheduling as a slot and also introduces a minislot (or a subslot or a non-slot-based schedule) in order to reduce a transmission delay of a radio section. If wide subcarrier spacing is used, the length of one slot is shortened in inverse proportion thereto, thereby reducing a transmission delay in the radio section. A minislot (or subslot) is intended to efficiently support URLLC scenarios, and the minislot may be scheduled in 2, 4, or 7 symbol units.

In addition, unlike LTE, NR defines uplink and downlink resource allocation as a symbol level in one slot. In order to reduce a HARQ delay, the slot structure capable of directly transmitting HARQ ACK/NACK in a transmission slot has been defined. Such a slot structure is referred to as a “self-contained structure”, which will be described.

NR was designed to support a total of 256 slot formats, and 62 slot formats thereof are used in 3GPP Rel-15. In addition, NR supports a common frame structure constituting an FDD or TDD frame through combinations of various slots. For example, NR supports i) a slot structure in which all symbols of a slot are configured for a downlink, ii) a slot structure in which all symbols are configured for an uplink, and iii) a slot structure in which downlink symbols and uplink symbols are mixed. In addition, NR supports data transmission that is scheduled to be distributed to one or more slots. Accordingly, the base station may inform the UE of whether the slot is a downlink slot, an uplink slot, or a flexible slot using a slot format indicator (SFI). The base station may inform a slot format by instructing, using the SFI, the index of a table configured through UE-specific RRC signaling. Further, the base station may dynamically instruct the slot format through downlink control information (DCI) or may statically or quasi-statically instruct the same through RRC signaling.

### <Physical Resources of NR>

With regard to physical resources in NR, antenna ports, resource grids, resource elements, resource blocks, bandwidth parts, and the like are taken into consideration.

The antenna port is defined to infer a channel carrying a symbol on an antenna port from the other channel carrying another symbol on the same antenna port. If large-scale properties of a channel carrying a symbol on an antenna port can be inferred from the other channel carrying a symbol on another antenna port, the two antenna ports may have a quasi-co-located or quasi-co-location (QC/QCL) relationship. The large-scale properties include at least one of delay spread, Doppler spread, a frequency shift, an average received power, and a received timing.

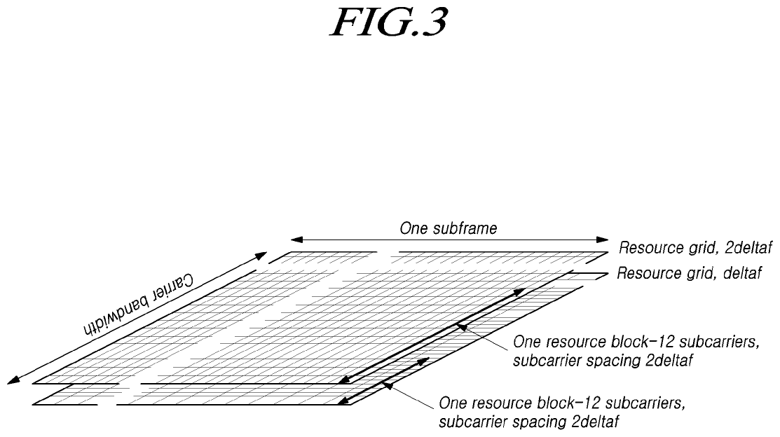

FIG. 3 illustrates resource grids supported by a radio access technology in accordance with embodiments of the present disclosure.

Referring to FIG. 3, resource grids may exist according to respective numerologies because NR supports a plurality of numerologies in the same carrier. In addition, the resource grids may exist depending on antenna ports, subcarrier spacing, and transmission directions.

A resource block includes 12 subcarriers and is defined only in the frequency domain. In addition, a resource element includes one OFDM symbol and one subcarrier. Therefore, as shown in FIG. 3, the size of one resource block may be varied according to the subcarrier spacing. Further, “Point A” that acts as a common reference point for the resource block grids, a common resource block, and a virtual resource block are defined in NR.

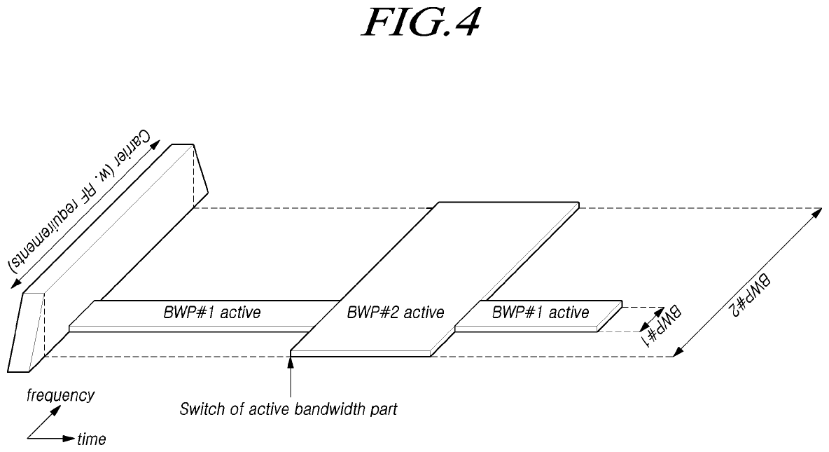

FIG. 4 illustrates bandwidth parts supported by a radio access technology in accordance with embodiments of the present disclosure.

Unlike LTE in which the carrier bandwidth is fixed to 20 MHz, the maximum carrier bandwidth is configured as 50 MHz to 400 MHz depending on the subcarrier spacing in NR. Therefore, it is not assumed that all UEs use the entire carrier bandwidth. Accordingly, as shown in FIG. 4, bandwidth parts (BWPs) may be specified within the carrier bandwidth in NR so that the UE may use the same. In addition, the bandwidth part may be associated with one numerology, may include a subset of consecutive common resource blocks, and may be activated dynamically over time. The UE has up to four bandwidth parts in each of the uplink and the downlink. The UE transmits and receives data using an activated bandwidth part during a given time.

In the case of a paired spectrum, uplink and downlink bandwidth parts are configured independently. In the case of an unpaired spectrum, in order to prevent unnecessary frequency re-tuning between a downlink operation and an uplink operation, the downlink bandwidth part and the uplink bandwidth part are configured in pairs to share a center frequency.

### <Initial Access in NR>

In NR, a UE performs a cell search and a random access procedure in order to access and communicates with a base station.

The cell search is a procedure of the UE for synchronizing with a cell of a corresponding base station using a synchronization signal block (SSB) transmitted from the base station and acquiring a physical-layer cell ID and system information.

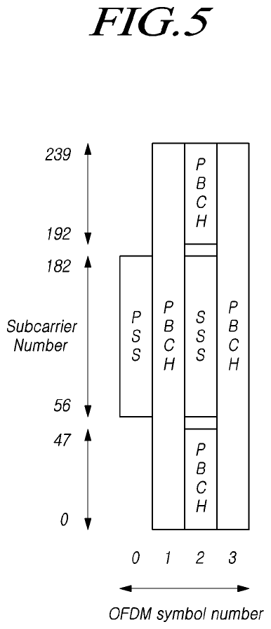

FIG. 5 illustrates an example of a synchronization signal block in a radio access technology in accordance with embodiments of the present disclosure.

Referring to FIG. 5, the SSB includes a primary synchronization signal (PSS) and a secondary synchronization signal (SSS), which occupy one symbol and 127 subcarriers, and PBCHs spanning three OFDM symbols and 240 subcarriers.

The UE monitors the SSB in the time and frequency domain, thereby receiving the SSB.

The SSB may be transmitted up to 64 times for 5 ms. A plurality of SSBs are transmitted by different transmission beams within a time of 5 ms, and the UE performs detection on the assumption that the SSB is transmitted every 20 ms based on a specific beam used for transmission. The number of beams that may be used for SSB transmission within 5 ms may be increased as the frequency band is increased. For example, up to 4 SSB beams may be transmitted at a frequency band of 3 GHz or less, and up to 8 SSB beams may be transmitted at a frequency band of 3 to 6 GHz. In addition, the SSBs may be transmitted using up to 64 different beams at a frequency band of 6 GHz or more.

One slot includes two SSBs, and a start symbol and the number of repetitions in the slot are determined according to subcarrier spacing as follows.

Unlike the SS in the typical LTE system, the SSB is not transmitted at the center frequency of a carrier bandwidth. That is, the SSB may also be transmitted at the frequency other than the center of the system band, and a plurality of SSBs may be transmitted in the frequency domain in the case of supporting a broadband operation. Accordingly, the UE monitors the SSB using a synchronization raster, which is a candidate frequency position for monitoring the SSB. A carrier raster and a synchronization raster, which are the center frequency position information of the channel for the initial connection, were newly defined in NR, and the synchronization raster may support a fast SSB search of the UE because the frequency spacing thereof is configured to be wider than that of the carrier raster.

The UE may acquire an MIB over the PBCH of the SSB. The MIB (master information block) includes minimum information for the UE to receive remaining minimum system information (RMSI) broadcast by the network. In addition, the PBCH may include information on the position of the first DM-RS symbol in the time domain, information for the UE to monitor SIB1 (e.g., SIB1 numerology information, information related to SIB1 CORESET, search space information, PDCCH-related parameter information, etc.), offset information between the common resource block and the SSB (the position of an absolute SSB in the carrier is transmitted via SIB1), and the like. The SIB1 numerology information is also applied to some messages used in the random access procedure for the UE to access the base station after completing the cell search procedure. For example, the numerology information of SIB1 may be applied to at least one of the messages 1 to 4 for the random access procedure.

The above-mentioned RMSI may mean SIB1 (system information block 1), and SIB1 is broadcast periodically (e.g., 160 ms) in the cell. SIB1 includes information necessary for the UE to perform the initial random access procedure, and SIB1 is periodically transmitted over a PDSCH. In order to receive SIB1, the UE must receive numerology information used for the SIB1 transmission and the CORESET (control resource set) information used for scheduling of SIB1 over a PBCH. The UE identifies scheduling information for SIB1 using SI-RNTI in the CORESET. The UE acquires SIB1 on the PDSCH according to scheduling information. The remaining SIBs other than SIB1 may be periodically transmitted, or the remaining SIBs may be transmitted according to the request of the UE.

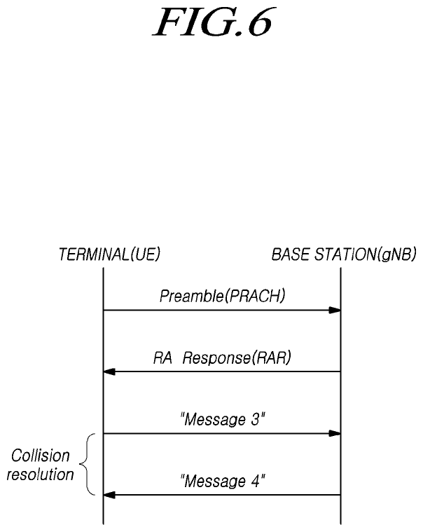

FIG. 6 is a view for explaining a random access procedure in a radio access technology to which the present embodiment is applicable.

Referring to FIG. 6, if a cell search is completed, the UE transmits a random access preamble for random access to the base station. The random access preamble is transmitted over a PRACH. Specifically, the random access preamble is periodically transmitted to the base station over the PRACH that includes consecutive radio resources in a specific slot repeated. In general, a contention-based random access procedure is performed when the UE makes initial access to a cell, and a non-contention-based random access procedure is performed when the UE performs random access for beam failure recovery (BFR).

The UE receives a random access response to the transmitted random access preamble. The random access response may include a random access preamble identifier (ID), UL Grant (uplink radio resource), a temporary C-RNTI (temporary cell-radio network temporary identifier), and a TAC (time alignment command). Since one random access response may include random access response information for one or more UEs, the random access preamble identifier may be included in order to indicate the UE for which the included UL Grant, temporary C-RNTI, and TAC are valid. The random access preamble identifier may be an identifier of the random access preamble received by the base station. The TAC may be included as information for the UE to adjust uplink synchronization. The random access response may be indicated by a random access identifier on the PDCCH, i.e., a random access-radio network temporary identifier (RA-RNTI).

Upon receiving a valid random access response, the UE processes information included in the random access response and performs scheduled transmission to the base station. For example, the UE applies the TAC and stores the temporary C-RNTI. In addition, the UE transmits, to the base station, data stored in the buffer of the UE or newly generated data using the UL Grant. In this case, information for identifying the UE must be included in the data.

Lastly, the UE receives a downlink message to resolve the contention.

### <NR CORESET>

The downlink control channel in NR is transmitted in a CORESET (control resource set) having a length of 1 to 3 symbols, and the downlink control channel transmits uplink/downlink scheduling information, an SFI (slot format index), TPC (transmit power control) information, and the like.

As described above, NR has introduced the concept of CORESET in order to secure the flexibility of a system. The CORESET (control resource set) refers to a time-frequency resource for a downlink control signal. The UE may decode a control channel candidate using one or more search spaces in the CORESET time-frequency resource. CORESET-specific QCL (quasi-colocation) assumption is configured and is used for the purpose of providing information on the characteristics of analogue beam directions, as well as delay spread, Doppler spread, Doppler shift, and an average delay, which are the characteristics assumed by existing QCL.

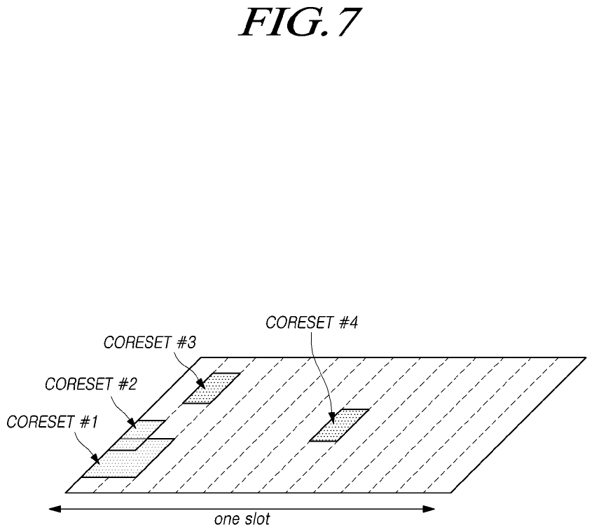

FIG. 7 illustrates CORESET.

Referring to FIG. 7, CORESETs may exist in various forms within a carrier bandwidth in a single slot, and the CORESET may include a maximum of 3 OFDM symbols in the time domain. In addition, the CORESET is defined as a multiple of six resource blocks up to the carrier bandwidth in the frequency domain.

A first CORESET, as a portion of the initial bandwidth part, is designated (e.g., instructed, assigned) through an MIB in order to receive additional configuration information and system information from a network. After establishing a connection with the base station, the UE may receive and configure one or more pieces of CORESET information through RRC signaling.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

### NR(New Radio)

NR is required to be designed not only to provide an improved data transmission rate but also to meet various QoS requirements for each detailed and specific usage scenario, compared to LTE/LTE-Advanced. In particular, enhanced mobile broadband (eMBB), massive machine-type communication (mMTC), and ultra reliable and low latency communication (URLLC) are defined as representative usage scenarios of NR. To meet requirements for each usage scenario, it is required to design NR to have a more flexible frame structure as compared to LTE/LTE-Advanced.

Since each usage scenario imposes different requirements for data rates, latency, coverage, etc., a method is required for efficiently multiplexing numerology-based (e.g., a subcarrier spacing (SCS), a subframe, a transmission time interval (TTI), etc.) radio resource units mutually different for efficiently satisfying requirements according to usage scenarios over a frequency band provided to NR system.

To this end, there have been discussions on i) methods of multiplexing numerologies having subcarrier spacing (SCS) values different from one another based on TDM, FDM or TDM/FDM over one NR carrier, and ii) methods of supporting one or more time units in configuring a scheduling unit in the time domain. In this regard, in NR, a subframe is defined as one type of a time domain structure. In addition, as a reference numerology to define a corresponding subframe duration, a single subframe duration is defined as having 14 OFDM symbols of normal CP overhead based on 15 kHz subcarrier spacing (SCS), similar to LTE. Therefore, the subframe of NR has a time duration of 1 ms. Unlike LTE, since the subframe of NR is an absolute reference time duration, a slot and a mini-slot may be defined as a time unit for actual UL/DL data scheduling. In this case, the number of OFDM symbols that constitutes a slot, a value y has been defined as y=14 regardless of the numerology.

Therefore, a slot may be made up of 14 symbols. In accordance with a transmission direction for a corresponding slot, all symbols may be used for DL transmission or UL transmission, or the symbols may be used in the configuration of a DL portion+a gap+a UL portion.

Further, a mini-slot has been defined to be made up of fewer symbols than the slot for a numerology (or SCS), and as a result, a short time domain scheduling interval may be configured for UL/DL data transmission or reception based on the mini-slot. Also, a long time domain scheduling interval may be configured for the UL/DL data transmission or reception by slot aggregation.

Particularly, in transmission or reception of latency critical data, such as the URLLC, when scheduling is performed on a slot basis based on 1 ms (14 symbols) defined in a frame structure based on a numerology having a small SCS value, for example, 15 kHz, latency requirements may be difficult to be satisfied. To this end, a mini-slot made up of fewer OFDM symbols than the slot may be defined, and thus the scheduling for the latency critical data, such as URLLC, may be performed based on the mini-slot.

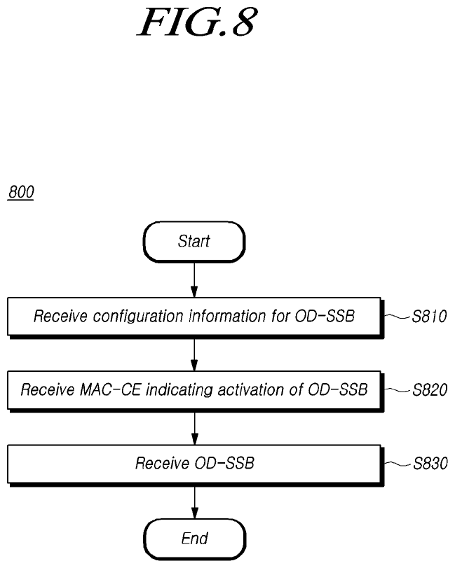

As described above, it may be contemplated to schedule data according to latency requirement based on the length of the slot (or minislot) defined by the numerology by supporting numerologies with the different SCS values in one NR carrier by multiplexing the numerologies in a TDM and/or FDM manner. For example, as shown in FIG. 8, when the SCS is 60 kHz, the symbol length is reduced to about ¼ of that of SCS 15 kHz. Therefore, when one slot is made up of 14 OFDM symbols, the slot length based on 15 kHz is 1 ms whereas the slot length based on 60 kHz is reduced to about 0.25 ms.

Thus, different SCSs or different TTI lengths are defined in NR, technologies have been developed for satisfying requirements of URLLC and eMBB.

### Wider Bandwidth Operations

The typical LTE system supports scalable bandwidth operations for any LTE CC (component carrier). That is, according to a frequency deployment scenario, an LTE provider may configure a bandwidth of a minimum of 1.4 MHz to a maximum of 20 MHz in configuring a single LTE CC, and a normal LTE UE supports a transmission/reception capability of a bandwidth of 20 MHz for a single LTE CC.

However, NR is designed to support the UE of NR having different transmission/reception bandwidth capabilities over a single wideband NR CC. Accordingly, it is required to configure one or more bandwidth parts (BWPs) including subdivided bandwidths for an NR CC, thereby supporting a flexible and wider bandwidth operation through configuration and activation of different bandwidth parts for respective UEs.

Specifically, one or more bandwidth parts may be configured through a single serving cell configured for a UE in NR, and the UE is defined to activate one downlink (DL) bandwidth part and one uplink (UL) bandwidth part to use the same for uplink/downlink data transmission/reception in the corresponding serving cell. In addition, in the case where a plurality of serving cells is configured for the UE (i.e., the UE to which CA is applied), the UE is also defined to activate one downlink bandwidth part and/or one uplink bandwidth part in each serving cell to use the same for uplink/downlink data transmission/reception by utilizing radio resources of the corresponding serving cell.

Specifically, an initial bandwidth part for an initial access procedure of a UE may be defined in a serving cell; one or more UE-specific bandwidth parts may be configured for each UE through dedicated RRC signaling, and a default bandwidth part for a fallback operation may be defined for each UE.

It is possible to define simultaneously activating and using a plurality of downlink and/or uplink bandwidth parts according to the capability of the UE and the configuration of the bandwidth parts in a serving cell. However, NR rel-15 defined activating and using only one downlink (DL) bandwidth part and one uplink (UL) bandwidth part at a time.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

In typical 3GPP NR, ten or more types of system information were transmitted in formats including System Information Block 1 (SIB1) and SIB2. Among these, information after SIB2 can be transmitted according to a request from a UE, but for SIB1, that transmits information essential for configuration of a connection such as a band in which transmission and reception are possible fora UE, SCS, and a random access resource space, transmission is always performed in a space determined by standards after a synchronization signal. Therefore, a UE that fails to receive corresponding information for various reasons cannot perform a follow-up procedure for accessing a network. However, SIB1, which must be transmitted for every synchronization signal, requires continuous transmission as long as the synchronization signal is sent even when there is no UE capable of accessing the network, which increases power consumption. It is determined that power saving of up to 50% or more is possible depending on scenarios if a base station with low actual traffic does not transmit SIB1.

Accordingly, there is a need for a specific method for a UE that is not currently in a Connected state to request corresponding information for a cell that is not transmitting SIB1.

A synchronization signal block (SSB) of typical NR comprises a Master Information Block (MIB) and some additional information in a payload, and is mainly composed of a frequency position, a selection of a primary synchronization signal/secondary synchronization signal (PSS/SSS), a position and value of a DeModulation Reference Signal (DMRS) in a Physical Broadcast Channel (PBCH), and contents of the PBCH. Among these, the PSS and SSS provide mainly cell ID related information, and the MIB provides, among basic information for cell access of a UE, position information of CORESET zero for delivering scheduling information of a PDSCH through which SIB1 may be transmitted, in addition to a frame number, subcarrier spacing information, band position information, and barring information. The additional information may mainly include some remaining bits of the frame number or remaining band position information that cannot be included in the MIB.

In particular, information named k_SSB determines an offset value between a starting frequency of the synchronization signal and Point A, which is a reference point of a band, and this value is delivered as 5-bit information in frequency range 1 (FR1) and 4-bit information in FR2. At this time, if the value of k_SSB is 24 or more for FR1 and 12 or more for FR2, the UE determines that SIB1 is not transmitted, and at this time, when k_SSB is a specific value, that is, between 24 and 29 for FR1 or between 12 and 13 for frequency range 2 (FR2), alternative SSB frequency position information from which SIB1 can be received may be indicated through existing CORESET zero position related information.

In a typical NR system, synchronization signals are required to include SIB1 configuration information, otherwise, an alternative synchronization signal including SIB1 position information is supported. If the alternative synchronization signal also does not comprise valid SIB1 configuration information, the UE does not access the corresponding cell. Therefore, unless SIB1 is transmitted in at least one band regardless of the presence or absence of a user, the UE cannot perform connection establishment with a base station.

The present disclosure may provide a synchronization signal operation method for a UE to access a wireless base station in a 3GPP NR system. In particular, the present disclosure provides a configuration and management method for radio resource management in an environment in which a base station performs SSB transmission by request under an energy saving function. The following description is described in detail below.

In typical 3GPP NR, at least one synchronization signal block (SSB) is transmitted within two frames, i.e., 20 ms, and the synchronization signal accounts for most of the power consumption in an environment in which no UE exists in a cell. To efficiently reduce power consumption in a wireless communication system, the following items may be defined.

1. Definition of Support Procedures and Signaling Methods for On-Demand SSB SCell Operation for a Connected Mode UE for which Intra-Band and Inter-Band Carrier Aggregation (CA) is Configured

Definition of a triggering method: the triggering method is defined by selecting from among an uplink wake-up signal transmitted by a UE using an existing signal/channel, a cell on/off indication through a backhaul, and SCell activation/deactivation signaling.

The on-demand SSB transmission may be used by the UE for at least SCell time/frequency synchronization, L1/L3 measurement, and SCell activation, and is supported in FR1 and FR2 environments of a non-shared spectrum.

### 2. Study of Support Procedures and Signaling Methods for On-Demand SIB1 (System Information Block 1) for UEs in an Idle/Inactive Mode

A triggering method based on an uplink wake-up signal using an existing signal/channel is studied. A method of providing wake-up signal configuration for the UE is studied. If necessary, a method of information exchange between base stations (gNBs) is studied for at least wake-up signal configuration.

### 3. Definition of Adaptation Methods for Common Signal/Channel Transmission

SSB adaptation in a time domain (e.g., adaptation of an SSB transmission period). PRACH (Physical Random Access Channel) adaptation in a time domain. Study of PRACH adaptation in a spatial domain (e.g., non-uniform PRACH resource allocation per SSB, etc.) and definition of the PRACH if an advantage is confirmed.

Paging occasion adaptation including limitation of paging occasions in a time domain. Upon application of the adaptation method, no increase should occur in paging latency, and no negative impact should occur on legacy UEs unless a significant advantage is proven.

Accordingly, a method for transmitting an SSB only when a request is present and a method of more broadly adjusting the transmission frequency of the SSB can be standardized. The request may be made by a UE or by a base station.

Typical SSB-related information may be delivered through SIB1 for the cell and through a ServingCellConfig message for a neighboring cell. The SSB-related information includes period-related information, time position-related information within a period, and similar information, and for the ServingCellConfig message, frequency position-related information and similar information may be also delivered. For an On-Demand SSB (hereinafter, OD-SSB), a corresponding configuration value may be delivered through a new RRC message, and parameters may be delivered through the RRC message as follows.

Frequency of the on-demand synchronization signal block: refers to an absolute frequency position (od-ssb-absoluteFrequency).

SSB positions within an on-demand SSB burst: indicates a time position within a burst using a signaling scheme (od-ssb-PositionsInBurst) similar to an existing ssb-PositionsInBurst.

Periodicity of the on-demand SSB: sets a transmission period (od-ssb-Periodicity) of an SSB transmitted on demand.

Subcarrier spacing of the on-demand SSB: defines a subcarrier spacing (od-ssbSubcarrierSpacing) applied to the synchronization signal block.

Physical cell identifier of the on-demand SSB: includes information on a physical cell identifier (od-ssb-physCellId) of a cell through which a corresponding signal is transmitted.

Time location of on-demand SSB burst: designates a location in a time domain through a system frame number offset (od-ssb-sfn-Offset) and a half frame index (od-ssb-halfFrameIndex).

Downlink transmit power of on-demand SSB: include a configuration value for a transmission power of a PBCH block (od-ss-PBCH-BlockPower).

Number N of on-demand SSB bursts: defines the total number of transmissions (od-ssb-nrofTx) of bursts to be transmitted after the on-demand SSB transmission is indicated.

In addition, the OD-SSB configured based on the parameters may be activated through RRC and MAC-CE, and may be deactivated based on a limit on the number of RRC transmissions or through the MAC-CE.

Operation of the OD-SSB is divided into two cases: Case #1 is a case in which another SSB does not exist in the SCell, and Case #2 is a case in which an SSB that is always transmitted (Always-On SSB, hereinafter referred to as AO-SSB) exists in the Scell. In addition, the OD-SSB may be configured not to be transmitted on a synchronization raster to prevent confusion of an initial access user.

In typical NR systems, SSB-related transmission remains unchanged, and even for an SSB-less SCell, whether the SSB is transmitted was recognized as remaining unchanged during a connection of a UE. However, for an on-demand SSB, whether the SSB recognized by the UE is transmitted changes during maintenance of the transmission, and operations corresponding to the change are unclear. In particular, discussions regarding a case in which adaptation is applied to the SSB or correlation of PositionInBurst information have not been conducted.

The present disclosure may provide a detailed operation method for an on-demand synchronization signal using a MAC-CE in an environment in which a base station operates an on-demand SSB in a 3GPP NR system.

Hereinafter, a method of a UE for receiving an On-Demand Synchronization Signal Block (OD-SSB) in wireless communication will be described in detail with reference to the related drawings.

FIG. 8 is a flowchart illustrating a procedure 800 for a UE to receive an on-demand synchronization signal in wireless communication according to an embodiment.

Referring to FIG. 8, a UE may receive a higher layer message including configuration information for an OD-SSB from a base station (S810).

The higher layer message may be a Radio Resource Control (RRC) message (e.g., OD-SSB-Config) for radio resource control between the base station and the UE. According to an example, the OD-SSB may be received through a Secondary Cell (SCell). However, the example is not limiting, and the present embodiment may be applied without being limited to a specific cell.

The higher layer message may comprise a plurality of candidate configuration values applicable to the OD-SSB of the SCell. That is, the base station may provide one or more configuration information sets for operating the OD-SSB to the UE in advance through the higher layer message. In this case, an OD-SSB operation environment in the SCell may include both a first case in which another synchronization signal block is not present in the corresponding SCell and a second case in which another synchronization signal block that is always transmitted (Always-On SSB, AO-SSB) is present in the corresponding SCell.

Specifically, the configuration information or the plurality of candidate configuration values may comprise at least one of a frequency of the on-demand synchronization signal block (Frequency of the on-demand SSB, e.g., od-ssb-absoluteFrequency), SSB positions within an on-demand SSB burst (SSB positions within an on-demand SSB burst, e.g., od-ssb-PositionsInBurst), a periodicity of the on-demand SSB (Periodicity of the on-demand SSB, e.g., od-ssb-Periodicity), a subcarrier spacing of the on-demand SSB (Sub-carrier spacing of the on-demand SSB, e.g., od-ssbSubcarrierSpacing), a physical cell identifier of the on-demand SSB (Physical Cell ID of the on-demand SSB, e.g., od-ssb-physCellId), a time location of an on-demand SSB burst (Time location of on-demand SSB burst, e.g., od-ssb-sfn-Offset and od-ssb-halfFrameIndex), and a downlink transmit power of the on-demand SSB (Downlink transmit power of on-demand SSB, e.g., od-ss-PBCH-BlockPower).

In addition, to prevent confusion during initial access by the UE, the frequency location of the OD-SSB configured by the configuration information may be configured not to be transmitted on a synchronization raster (sync raster), which is a basic frequency search grid for initial access.

In particular, the configuration information may optionally comprise a parameter related to a number of transmissions (Number N of on-demand SSB bursts) of an on-demand SSB burst to be transmitted after activation of the OD-SSB (e.g., od-ssb-nrofTx or od-ssb-NrofBursts). As described in step S830 below, receiving of the OD-SSB by the UE may be performed based on whether the parameter related to the number of transmissions of the OD-SSB is included in the configuration information.

Referring back to FIG. 8, the UE may receive a first Medium Access Control-Control Element (MAC-CE) indicating activation of the OD-SSB from the base station (S820).

As described above, after the base station provides configuration information for OD-SSB operation to the UE in advance through a higher layer message (RRC), the base station may transmit the first MAC-CE to the UE to dynamically start (activate) transmission of the OD-SSB according to network traffic conditions or whether a UE attempts to access the cell. The UE may determine that the base station starts the OD-SSB transmission by receiving the first MAC-CE and switch to a reception standby state.

According to an example, the first MAC-CE may indicate a configuration index to be applied to the SCell among the plurality of candidate configuration values previously received. That is, when the base station presets a plurality of candidate configuration values applicable to the OD-SSB of the SCell through the higher layer message, the first MAC-CE may indicate which configuration value is applied along with an activation indication.

For example, the first MAC-CE may include a cell identifier field (e.g., SCellIndex) indicating a specific SCell in which the OD-SSB is activated, and a configuration index field (e.g., ConfigIndex) indicating one configuration value to be applied to the SCell among the plurality of candidate configuration values previously set by RRC (e.g., a configuration list distinguished by OD-SSB-ConfigId).

Accordingly, by separately performing the presetting through the RRC message and the dynamic activation and index indication through the MAC-CE, the on-demand synchronization signal may be controlled quickly and flexibly while minimizing latency without performing RRC connection reconfiguration (RRC Reconfiguration) every time according to changes in the system environment.

Referring back to FIG. 8, the UE may receive the OD-SSB based on the configuration information and the first MAC-CE (S830).

The receiving of the OD-SSB is performed based on different manners based on whether a parameter related to the number of transmissions of the OD-SSB is included in the configuration information.

According to an embodiment, when the parameter related to the number of transmissions is included in the configuration information, the receiving of the OD-SSB may be deactivated after the OD-SSB is received a number of times indicated by the parameter from an activation time indicated through the first MAC-CE. That is, when the base station explicitly sets the number of transmissions N in advance through the higher layer message, if the UE receives N OD-SSB bursts according to a set period and the number of transmissions after receiving the first MAC-CE, the UE may perform an implicit deactivation procedure to stop the receiving of the OD-SSB without external control without a separate indication from the base station. Accordingly, waste of downlink control resources can be prevented and signaling overhead can be significantly reduced.

According to another embodiment, when the parameter related to the number of transmissions is not included in the configuration information, the receiving of the OD-SSB may be maintained until a second MAC-CE or an additional higher layer message indicating deactivation of the OD-SSB is received from the base station. In other words, in a situation where a finite number of transmissions is not specified, the UE may assume that the base station continues transmitting the OD-SSB in the cell until an explicit deactivation indication such as the second MAC-CE is received, and maintains a reception standby state. This may provide seamless and stable synchronization when the base station needs to flexibly extend the synchronization signal transmission period according to network conditions.

According to yet another embodiment, a priority control mechanism may be applied to an exceptional situation where an explicit deactivation indication from the base station conflicts with the parameter related to the number of transmissions is set. Specifically, when a second MAC-CE indicating deactivation of the OD-SSB is received from the base station before the OD-SSB is received the number of times indicated by the parameter, the receiving of the OD-SSB may be stopped based on an indication of the second MAC-CE. Alternatively, in this case, the receiving of the OD-SSB may be maintained for the number of transmissions indicated by the parameter.

That is, the UE may follow the latest scheduling intention of the base station by applying the indication of the newly received second MAC-CE as a priority and immediately stopping receiving. Alternatively, the UE may ignore the second MAC-CE and stop receiving after completing the number of times originally indicated. Accordingly, malfunctions due to operational inconsistency between the base station and the UE can be prevented, and overall system reliability can be maximized.

According to the embodiments described above, a synchronization signal and system information may be efficiently transmitted by transmitting and receiving an on-demand synchronization signal in wireless communication. In addition, efficient synchronization signal transmission management can be supported in an environment where a base station operates an on-demand SSB.

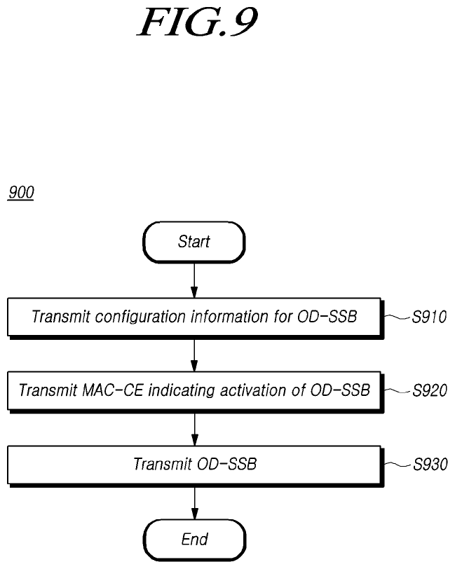

FIG. 9 is a flowchart illustrating a procedure 900 for a base station to transmit an on-demand synchronization signal in wireless communication according to an embodiment.

Referring to FIG. 9, the base station may transmit, to the UE, a higher layer message comprising configuration information for the OD-SSB (S910).

The higher layer message may be a Radio Resource Control (RRC) message (e.g., OD-SSB-Config) for radio resource control between the base station and the UE. According to an embodiment, the OD-SSB may be transmitted through a Secondary Cell (SCell). However, the example is not limiting, and the present embodiment is not limited to a specific cell as long as the present embodiments may be applied.

The higher layer message may comprise a plurality of candidate configuration values applicable to the OD-SSB of the SCell. That is, the base station may provide one or more configuration information sets for operating the OD-SSB to the UE in advance through the higher layer message. In this case, an OD-SSB operation environment in the SCell may include both a first case in which another synchronization signal block is not present in the corresponding SCell and a second case in which another synchronization signal block that is always transmitted (Always-On SSB, AO-SSB) is present in the corresponding SCell.

Specifically, the configuration information or the plurality of candidate configuration values may include at least one of a frequency of the on-demand synchronization signal block (e.g., od-ssb-absoluteFrequency), SSB positions within an on-demand SSB burst (e.g., od-ssb-PositionsInBurst), a periodicity of the on-demand SSB (e.g., od-ssb-Periodicity), a subcarrier spacing of the on-demand SSB (e.g., od-ssbSubcarrierSpacing), a physical cell identifier of the on-demand SSB (e.g., od-ssb-physCellId), a time location of the on-demand SSB burst (e.g., od-ssb-sfn-Offset and od-ssb-halfFrameIndex), and a downlink transmit power of the on-demand SSB (e.g., od-ss-PBCH-BlockPower).

In addition, to prevent confusion during initial access of the UE, a frequency position of the OD-SSB configured by the configuration information may be configured not to be transmitted on a synchronization raster (sync raster), which is a basic frequency search grid for initial access.

In particular, the configuration information may optionally include a parameter (e.g., od-ssb-nrofTx or od-ssb-NrofBursts) related to a number N of on-demand SSB bursts to be transmitted after activation of the OD-SSB. As described in step S930 below, the transmitting of the OD-SSB by the base station may be performed based on whether a parameter related to the number of transmissions of the OD-SSB is included in the configuration information.

Referring back to FIG. 9, the base station may transmit, to the UE, a first Medium Access Control-Control Element (MAC-CE) indicating activation of the OD-SSB (S920).

As described above, the base station may provide configuration information for OD-SSB operation to the UE in advance through a higher layer message (RRC) and transmit a first MAC-CE to the UE to dynamically start (activate) transmission of the OD-SSB according to network traffic conditions, whether a UE attempts to access the cell. By transmitting the first MAC-CE, the base station may inform the UE of the start of OD-SSB transmission and switch to a transmission state.

According to an embodiment, the first MAC-CE may indicate a predetermined configuration index (Configuration Index) to be applied to an SCell among a plurality of candidate configuration values previously transmitted. That is, when the base station pre-configures a plurality of candidate configuration values applicable to the OD-SSB of the SCell through a higher layer message, the first MAC-CE may indicate which configuration value is applied along with an activation indication.

For example, the first MAC-CE may be configured to comprise a cell identifier field (e.g., SCellIndex) indicating a specific SCell in which the OD-SSB is activated, and a configuration index field (e.g., ConfigIndex) indicating one configuration value to be applied to the SCell among a plurality of candidate configuration values (e.g., a configuration list distinguished by OD-SSB-ConfigId) previously configured through RRC.

As described above, by separately operating pre-configuration through an RRC message and dynamic activation and index indication through a MAC-CE, an on-demand synchronization signal may be controlled quickly and flexibly while minimizing latency (Latency) without performing RRC connection reconfiguration (RRC Reconfiguration) every time according to changes in the system environment.

Referring back to FIG. 9, the base station may transmit an OD-SSB based on the configuration information and the first MAC-CE (S930).

The transmission of the OD-SSB is performed differently depending on whether a parameter related to a number of transmissions of the OD-SSB is included in the configuration information.

According to an embodiment, when the parameter related to the number of transmissions is included in the configuration information, the transmission of the OD-SSB may be deactivated after the OD-SSB is transmitted a number of times indicated by the parameter from an activation time indicated through the first MAC-CE. That is, when the base station explicitly configures the number of transmissions N in advance through a higher layer message, the base station may perform an implicit deactivation procedure of stopping the transmission of the OD-SSB without additional control a separate additional indication once all $N$ OD-SSB bursts are transmitted according to a configured period and the number of transmissions after transmitting the first MAC-CE. Accordingly, it is possible to prevent waste of downlink control resources and significantly reduce signaling overhead.

According to another embodiment, when the parameter related to the number of transmissions is not included in the configuration information, the transmission of the OD-SSB may be maintained until a second MAC-CE or an additional higher layer message indicating deactivation of the OD-SSB is transmitted to the UE. In other words, in a situation where a finite number of transmissions is not designated, the base station maintains transmission of the OD-SSB in the corresponding cell until transmitting an explicit deactivation indication such as the second MAC-CE. This provides seamless and stable synchronization when the base station needs to flexibly maintain a synchronization signal transmission period for an extended period according to network conditions.

According to yet another embodiment, a priority control mechanism may be applied to an exceptional situation in which an explicit deactivation indication from the base station conflicts with a parameter related to the number of transmissions is configured. Specifically, when a second MAC-CE indicating deactivation of the OD-SSB is transmitted to the UE before the OD-SSB is transmitted the number of times indicated by the parameter, the transmission of the OD-SSB may be stopped based on an indication of the second MAC-CE. Alternatively, in this case, the transmission of the OD-SSB may be maintained for the number of transmissions indicated by the parameter.

That is, the base station may reflect a latest scheduling intention of the base station by immediately stopping the transmission in consideration that the UE applies the indication of the newly transmitted second MAC-CE with priority. Conversely, the base station may stop the transmission after completing the number of transmissions originally indicated even if the second MAC-CE is transmitted. Accordingly, it is possible to prevent a malfunction due to an operational mismatch between the base station and the UE and maximize overall system reliability.

According to the embodiments described above, a synchronization signal and system information may be efficiently transmitted by transmitting and receiving an on-demand synchronization signal in wireless communication. In addition, it is possible to support efficient synchronization signal transmission management in an environment where a base station operates an on-demand SSB.

Hereinafter, each embodiment of a method for transmitting and receiving an On-Demand Synchronization Signal Block (OD-SSB) in a wireless communication system will be described in detail with reference to the related drawings.

The present disclosure broadly provides (1) an OD-SSB operation method using an activation MAC-CE, and (2) an OD-SSB operation method using a deactivation MAC-CE.

### Embodiment 1. OD-SSB Operation Method Using Activation MAC-CE

This method is a specific operation method in a situation in which an OD-SSB is operated through a MAC-CE. First, activation through a MAC-CE may be performed only when a number of transmissions N of the OD-SSB pre-configured through RRC is set to a specific value. For example, the configuration may be set such that only activation through a MAC-CE is possible when the number of transmissions N of the OD-SSB is 0.

When N is greater than 0, an activation message through a MAC-CE may perform one of the following roles.
N-counter reset: the message may indicate that transmission is performed again N times after the MAC-CE is received, regardless of the number of previous transmissions.
Indicating that the OD-SSB is transmitted continuously at a configured period until a deactivation message is received
Ignoring the corresponding message: the message may cause activation by the MAC-CE to be ignored.
Performing deactivation: the message may indicate that a deactivation procedure is performed when the corresponding message is received while the OD-SSB is currently activated, before transmission is performed N times, or before a certain timer elapses after activation. Accordingly, deactivation of the OD-SSB may be performed without separately defining a deactivation MAC-CE.

In addition, an activation message may include information on the number of transmissions of the OD-SSB, or information on the number of transmissions expressed as an offset value relative to the number of transmissions configured during pre-configuration. Specifically, one or more of the following information may be included in the activation MAC-CE.
Information related to the number of transmissions of the OD-SSB to be additionally transmitted after the activation MAC-CE is received, which is expressed as a specific number of transmissions or in the form of the number of transmissions performed until previously or a multiple of a pre-configured N
A total number of transmissions of the OD-SSB to be transmitted after the activation MAC-CE is received, from initial activation, which is expressed as a specific number of transmissions or in the form of the number of transmissions previously performed or a multiple of a pre-configured N
An offset between a total number of transmissions of the OD-SSB to be transmitted after the activation MAC-CE is received, from initial activation, and an initial N value
Information related to an OD-SSB transmission time for which transmission is additionally maintained after the activation MAC-CE is received, which is expressed in terms of time, a slot length, a symbol length, or the like

Operation for the information may vary depending on whether an existing configured N value exists. For example, deactivation based on the existing N value may be prioritized. Alternatively, a newly defined time point may be prioritized over a deactivation time point configured by the existing N value or a previous MAC-CE.

### Embodiment 2. Method for Operating OD-SSB Using Deactivation MAC-CE

The method is a specific operation method in a case in which a deactivation MAC-CE is defined in a situation in which the OD-SSB is operated through a MAC-CE. First, activation through a MAC-CE may be enabled only when the number of transmissions N of the OD-SSB is configured to a specific value. For example, when the number of transmissions N of the OD-SSB is 0, the configuration may be set such that only deactivation through a MAC-CE is possible.

When N is greater than 0, a deactivation message through a MAC-CE may be ignored. That is, transmission may always be performed N times regardless of whether a deactivation message is received.

In addition, a deactivation message may include information on the number of transmissions of the OD-SSB, or information on the number of transmissions expressed as an offset value relative to the number of transmissions configured during pre-configuration. Specifically, one or more of the following information may be included in the deactivation MAC-CE.
Information related to the number of transmissions of the OD-SSB to be additionally transmitted after the deactivation MAC-CE is received, which is expressed as a specific number of transmissions or in the form of the number of transmissions previously performed or a multiple of a pre-configured N
A total number of transmissions of the OD-SSB to be transmitted after the deactivation MAC-CE is received, from initial activation, which is expressed as a specific number of transmissions or in the form of the number of transmissions previously performed or a multiple of a pre-configured N
an offset between an initial N value and a total number of transmissions of the OD-SSB to be transmitted after the deactivation MAC-CE is received, from initial activation
OD-SSB transmission time related information, expressed as time, a slot length, a symbol length, or the like, for which transmission is additionally maintained after the deactivation MAC-CE is received

The information may vary in operation depending on whether an existing configured N value exists. For example, deactivation based on an existing N value may be prioritized. Alternatively, a newly defined timing may be prioritized over a deactivation timing set by the existing N value or a previous MAC-CE.

The methods provided in the present disclosure may be applied independently or may be operated in combination in any form. In addition, for terms used in the present disclosure, in the case of new terms, arbitrary names that are easy to understand are used, and the present disclosure may be applied even when other terms having the same meaning are actually used. In addition, although the present disclosure assumes an environment in which an SSB is transmitted based on OD-SSB, the method of the present disclosure may be applied to all environments in which an SSB transmission condition changes during connection, such as an Adaptive SSB.

According to the embodiments described above, by transmitting and receiving an OD-SSB in wireless communication, a synchronization signal and system information may be efficiently transmitted. In addition, it is possible to support efficient synchronization signal transmission management in an environment where a base station operates an OD-SSB.

### Embodiment 3. Method for Configuring SIB1 Request Signal

The method provides a signal format and content transmitted through a resource by a UE that has received uplink resource information for transmitting an SIB request.

### \textcircled{1} Format of SIB1 Request Signal

First, a signal format may be a Random Access (RA) preamble or a part of the RA preamble. Alternatively, the signal format may be a Sounding Reference Signal (SRS). Alternatively, the signal format may be newly defined Uplink Control Information (UCI). Alternatively, the signal format may reuse UCI such as a Scheduling Request (SR). Alternatively, a request signal may be transmitted and transmitted on a PUSCH by selecting an MCS designated by the base station or preset, for example, index 0. In this case, as a Radio Network Temporary Identifier (RNTI), an SI-RNTI may be used, or another predefined constant RNTI may be used. Alternatively, an RNTI configured in advance by the base station may be used, or an RNTI calculated based on information delivered by the SSB or information included in SIB1 resource configuration information may be used.

When a payload size of the UE is 1 or more bits, the payload may be indicated, in the case of a PRACH, by selecting one of a plurality of preset sequences and by selecting one of a plurality of pre-RACH occasion spaces defined by a cyclic shift value and a transmission resource space, or a combination thereof. In the case of an SRS, the payload may be indicated by selecting one of a plurality of preset sequences and a cyclic shift value and a transmission resource space, or a combination of the selections. In the case of a PUCCH, a method of configuring a payload and a method of encoding in existing PUCCH formats 0, 1, 2, 3, etc. may be applied, and in particular, when payload size information is indicated in a request signal scheduling process of the base station, a corresponding PUCCH format may be determined.

### \textcircled{2} Method for Configuring SIB1 Request Signal Payload

When a payload size of a request signal transmitted by the UE is 0 or a field indicating whether to request an SIB is not included in the payload, the base station may perform SIB1 transmission upon detecting the request signal, or when the payload size is 1 or more, the request signal may include one or more of the following information.
whether to request SIB1 transmission
whether to request an ACK (Acknowledgement) for the SIB1 transmission request
preferred band related information
a preferred time offset (a minimum or maximum interval between a request signal and an SIB1 signal)
Information related to a request maintenance time or a number of times for the base station to maintain SIB1 transmission

### Priority

A part of information related to UE (User Equipment) capability: a UE category, an available bandwidth, whether HD (Half-Duplex)-FDD is used, etc.
Cyclic Redundancy Check (CRC) (using SI-RNTI, a new constant RNTI, or an RNTI indicated to the base station)

### Embodiment 4. Subsequent Operation Method of the Base Station According to a SIB1 Request

This method is a subsequent operation method for a case in which the base station receives a request signal transmitted according to Embodiment 3. The method may be classified into a method for sending an ACK for the request, a method for retransmitting an SSB including SIB1 configuration information, and a method of transmitting only the SIB1 without an SSB.

### \textcircled{1} Method of Sending an ACK for a Request

The base station may transmit a preset ACK to the UE (User Equipment) to support fast feedback on whether the base station will transmit the SIB1. This may be performed by transmitting a special SSB of a preset form or transmitting DCI of a preset form to CORESET zero. Alternatively, scheduling information for the ACK may be notified by the base station in advance. Transmission of the ACK may always be performed upon a SIB1 request, or may be performed when requested by the UE (User Equipment). In addition to the ACK, a negative acknowledgement (NACK) indicating that SIB1 transmission will not be performed may be transmitted. When a payload size of the ACK is 1 or more bits, the payload may include one or more of the following.
Whether ACK/NACK is used
Information related to a CORESET space where SIB1 scheduling DCI is to be transmitted
Information related to a time when SIB1 scheduling DCI is to be transmitted
Information related to an SSB transmission time including SIB1 configuration information
Information related to an SSB band including SIB1 configuration information
Uplink resource information for an alternative SIB1 request

According to the ACK message, the UE (User Equipment) may not perform cell access, may receive SIB1 information at a location notified by the base station, or may retransmit a SIB1 transmission request message that is identical or in a form improved compared to an initial form.

### \textcircled{2} Method of Retransmitting an SSB

The base station may perform a legacy operation in which SIB1 is included for a next SSB in response to a request from a UE. The meaning of the next SSB may be an earliest SSB after receiving the request within the same band. Alternatively, it may be an SSB at the same position (index) in a next period (20 ms). The initial SSB referred to by the UE and an SSB comprising SIB1 configuration information are transmitted with a 20 ms difference. Alternatively, it may be a first SSB at the same position (index) after a UE request signal or an ACK signal for the request. For example, this may be applied when a time gap between the initial SSB and a transmission end timing of the UE request signal is 20 ms or more. Alternatively, SIB1 scheduling information may be included in an SSB after a time defined in a standard or requested by the UE, other than the first one. A minimum or maximum required time gap between the UE request signal and the SSB comprising SIB1 configuration information may be defined in the standard, notified by the base station, or requested by the UE.

An SSB performing the SIB1 legacy operation may be transmitted in a band different from that of an initial SSB received by the UE. In this case, an existing method of indicating another band, i.e., when k_SSB is a specific value, i.e., between 24 and 29 for FR1 or between 12 and 13 for FR2, an alternative SSB frequency position delivered through controlResourceSetZero and searchSpzceZero may be an SSB band performing the legacy operation. Alternatively, the SSB performing the SIB1 legacy operation may be one of previously unused SSB indices. For example, a base station that transmitted an SSB only at a first index to save power may transmit an SSB comprising SIB1 indication information at a second index. Such an index offset value may be predefined or notified by the base station. Additionally, a Quasi Co-Location (QCL) relationship may be maintained between the SSB initially recognized by the UE and the SSB comprising SIB1 information as a request response.

### \textcircled{3} Method of not Re-Sending an SSB

As another method, DCI for SIB1 scheduling in CORESET zero defined in an existing SSB may be provided based on the request. The DCI may use the same format as DCI for scheduling existing SIB1 transmission, may be transmitted at a defined time, after the defined time, or within the defined time, and the time may be defined in physical units or slot units, and the value may be defined in the standard, notified by the base station, or requested by the UE.

The SIB1 transmission may be performed only once per request, or may be performed for a time predefined in the standard. For example, all SSBs of a frame following a frame in which the request is made may comprise SIB1 information. Alternatively, under the same condition, it may be performed periodically for a number of times determined in the standard, notified in advance by the base station, or requested by the UE.

Example 1: When a UE transmits Priority information of the UE by including the priority information in a request, a base station may transmit SIB1 within a time determined based on a value dependent on the Priority indicated in the request of the UE, for a number of times equal to a value dependent on the Priority.

Additionally, the present disclosure provides a method in which a base station may provide, through synchronization signal information, a space in which a UE may request system information transmission from a wireless base station in a 3GPP NR system. In particular, a method is provided of notifying the UE that an On-Demand SIB request is possible, or notifying a space in which the UE may request SIB1 transmission without SIB1 reception.

The present disclosure provides a method of notifying that a cell transmits SIB1 on-demand, and a method of notifying a space for transmitting a request signal to a UE.

### Embodiment 5. Method of Notifying that a Cell Transmits SIB1 On-Demand

This method may be divided into a method of preventing a legacy UE that does not support an SIB1 request function from accessing a base station, and a method for notifying a UE supporting the SIB1 request function whether the base station supports the SIB1 request function.

### \textcircled{1} Method of Preventing Access by a Legacy UE

A base station that does not transmit SIB1 may indicate Barring in a synchronization process, i.e., to prevent access to a cell, so that a legacy UE that does not support the SIB1 request function does not malfunction. The indication may be performed by setting cellBarred of a MIB to Enabled. Alternatively, a method for using an invalid value for a value of k_SSB indicating a frequency offset, i.e., a value of 24 or more for FR1 and 12 or more for FR2, may be used. Alternatively, although k_SSB is valid, a method for indicating values of controlResourceSetZero and searchSpzceZero, which are parameters related to a position of CORESET zero indicated in a table format, as a reserved area not provided in an existing table may be used. Alternatively, two or more of the above methods may be used in combination.

### \textcircled{2}Method of Notifying Whether the Corresponding Base Station Supports the SIB1 Request Function

By using a specific combination of information that a base station can deliver through an SSB, a UE supporting On-Demand SIB1 may recognize that the indication corresponds to a base station requiring an SIB1 request. For higher efficiency, the combination may be recognize as Barring by a legacy UE. For example, when k_SSB is delivered as a specific value or one of multiple values, or when cellBarred is additionally set to Enabled, or k_SSB is a specific value or one of multiple values and values of controlResourceSetZero and searchSpzceZero are a specific value or one of values, the UE may determine that the indication corresponds to a base station requiring an SIB1 request. The specific value may be a constant or may be determined based on a cell ID, k_SSB, a system frame number, or other values delivered in the SSB. In determining the combination, for example, a Global Synchronization Channel Number (GSCN) value, a cell ID, a frame number, an SSB index, an SSB arrangement pattern, etc., which are not involved in Barring of existing users (e.g., legacy UEs), may be additionally or independently applied.
Example 1: In FR1, a base station may transmit k_SSB with a value of 30 to cause the UE to recognize that the base station is a base station requiring an SIB1 request.
Example 2: In FR1, when a subcarrier spacing (SCS) of SS/PBCH is 15 kHz and an SCS of PDCCH is 15 kHz, a base station may transmit controlResourceSetZero with a value of 15 to cause the UE to recognize that the base station is a base station requiring an SIB1 request.
Example 3: The base station may use a specific value for a GSCN value of an SSB and set cellBarred to Enabled to cause the UE to recognize that the base station is a base station requiring an SIB1 request.

### Embodiment 6. Method of Informing UE of Space for Sending Request Signal

The method may be divided into a method in which the UE recognizes whether a base station transmitting an SSB is a base station requiring an SIB1 request based on Embodiment 5, and a method in which recognition is not required.

\textcircled{1}Method in which there is a Need to Recognize Whether a Base Station Requires an SIB1 Request

When the UE determines that the base station is configured to receive an SIB1 request based on Embodiment 5 or other means, the UE may transmit an SIB1 request signal through a space indicated by a k_SSB value, a controlResourceSetZero value, and a searchSpzceZero value. For example, a location of an uplink resource may be specified through the controlResourceSetZero, and a format of a signal may be specified through the searchSpzceZero. The location of the uplink resource may be a same space as a space indicated for an existing CORESET zero, or may be represented by a separate table.

As another method, a location determined relative to an SSB is specified by standards. For example, a specific SSB may be always transmitted in a slot preceding an uplink, and a correlation of an SIB1 request transmission resource location within the slot may be specified. Whether the method is used may be determined according to band conditions or the like, and when not used, a method in which recognition is not required whether a base station requires an SIB1 request may be applied instead.
Example 1: Band or slot information may be delivered by the controlResourceSetZero and/or the searchSpzceZero. For example, when a space in which an SSB exists is a Time Division Duplex (TDD) band, slot offset information may be included, and when the band is a Frequency Division Duplex (FDD) band, band information may be included, and may be delivered in a multiplexing form of the two. The information may be configured in a table format or may be expressed in a form of a band number or a band index within a paired band.
Example 2: In a case of an FDD band, or in a case in which a GSCN corresponds to a specific value or a set of values within a specific range, the method may not be used, and instead, a method in which recognition is not required whether a base station requires an SIB1 request may be used.
   \textcircled{2}Method in which there is No Need to Recognize Whether a Base Station Requires an SIB1 Request

The method is a method applicable to both cases in which it is recognized or not recognized whether a base station requires an SIB1 request based on the method provided in Embodiment 5 or other means. For this purpose, the base station may define a new DCI that is transmitted through a CORESET zero transmission space indicated through a ControlResourceSetZero value and a searchSpzceZero value. This may be newly defined as, for example, DCI format 2-x, and may be scrambled with an SI-RNTI, another predefined constant value, or an RNTI derivable from information obtainable from an SSB such as a cell ID. The corresponding DCI may comprise one or more of the following information.
Uplink transmission space band information through which the UE can send an SIB request
Frequency location information within an uplink transmission space band through which the UE can send an SIB request
Time location information within an uplink transmission space band through which the UE can send an SIB request
Subcarrier spacing information of an uplink transmission space band through which the UE can send an SIB request
A signal format to be used by the UE for an SIB request: a Physical Random Access Channel (PRACH) format, a sequence to be used, a type of Physical Uplink Control Channel (PUCCH), a Modulation Coding Scheme (MCS), etc.
SIB types requestable by the UE
PDSCH resource allocation information through which an SIB is to be transmitted upon request of the UE
new CORESET information through which SIB scheduling information is to be transmitted upon request of the UE or whether to reuse a current CORESET
resource allocation information through which an ACK/NACK or other feedback is to be transmitted when the UE transmits an SIB request
an RNTI to be used by the UE when transmitting a request

As another method, the base station may obtain one or more of the information related to the transmission space based on cell configuration information received from a previous cell. The cell configuration information may include information related to an SSB configuration value of a cell to which On-Demand SIB1 is applied and information including a relative uplink resource location, a format, and the like.

The method is a method that does not require recognition of whether a base station requires an SIB1 request, and may also be applied when the UE recognizes.

Each of the embodiments provided in the present disclosure may be independently applied or may be operated in combination in any form. In addition, for new terms used in the present disclosure, arbitrary names that are easy to understand are used, and even when other terms having the same meaning are actually used, the technical idea of the present disclosure may be equally applied.

Hereinafter, configurations of a UE and a base station configured to perform part or all of the embodiments described with reference to FIGS. 1 to 9 will be described with reference to the drawings. The description above may be omitted to avoid redundancy, and in this case, the omitted content may be applied to the following description as long as the description does not contradict the present disclosure.

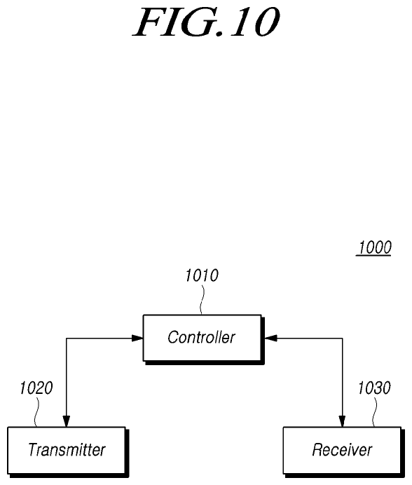

FIG. 10 is a block diagram illustrating a UE 1000 according to an embodiment.

Referring to FIG. 10, a UE 1000 according to an embodiment include a transmitter 1020, a receiver 1030, and a controller 1010 configured to control operations of the transmitter and the receiver.

The controller 1010 controls overall operations of the UE 1000 according to a method of receiving an on-demand synchronization signal in wireless communication, which is necessary to perform the present invention described above.

The controller 1010 may receive, from a base station, a higher layer message comprising configuration information for an OD-SSB. The higher layer message may be an RRC message for radio resource control between the base station and the UE.

According to an embodiment, the OD-SSB is received through a Secondary Cell (SCell), and the higher layer message may comprise a plurality of candidate configuration values applicable to the OD-SSB of the SCell. Specific parameters (e.g., frequency, periodicity, subcarrier spacing, etc.) included in the configuration information and the plurality of candidate configuration values, frequency location configuration related to a synchronization raster (sync raster) are substantially identical to those described above with reference to FIG. 8, and thus detailed description is omitted herein.

In addition, the controller 1010 may receive, from the base station, a first MAC-CE indicating activation of the OD-SSB.

According to an embodiment, the first MAC-CE may indicate a configuration index to be applied to the SCell among the plurality of candidate configuration values. Accordingly, the controller 1010 may identify a configuration value to be quickly applied while minimizing latency without performing RRC connection reconfiguration.

Subsequently, the controller 1010 may receive the OD-SSB based on the configuration information and the first MAC-CE.

Receiving of the OD-SSB by the controller 1010 is performed depending on whether a parameter related to a number of transmissions of the OD-SSB is included in the configuration information.

According to an embodiment, when the parameter related to the number of transmissions is included in the configuration information, the receiving of the OD-SSB may be deactivated after the OD-SSB is received a number of times indicated by the parameter from an activation time indicated through the first MAC-CE. That is, when receiving is completed a preset number of times, the controller 1010 may perform an implicit deactivation procedure to stop receiving of the OD-SSB without external control without a separate indication from the base station.

According to another embodiment, when the parameter related to the number of transmissions is not included in the configuration information, the receiving of the OD-SSB may be maintained until a second MAC-CE or an additional higher layer message indicating deactivation of the OD-SSB is received from the base station. That is, the controller 1010 may control to maintain a reception standby state until an explicit deactivation indication is received in a situation where a finite number of transmissions is not specified.

According to yet another embodiment, in an exceptional situation in which an explicit deactivation indication from the base station conflicts with the parameter related to the number of transmissions is set, the controller 1010 may apply a priority control mechanism. Specifically, when a second MAC-CE indicating deactivation of the OD-SSB is received from the base station before the OD-SSB is received the number of times indicated by the parameter, the receiving of the OD-SSB may be stopped based on an indication of the second MAC-CE, or the receiving of the OD-SSB may be maintained for the number of transmissions indicated by the parameter.

According to the embodiments described above, by transmitting and receiving an on-demand synchronization signal in wireless communication, a synchronization signal and system information may be efficiently transmitted. In addition, efficient synchronization signal transmission management can be supported in an environment where a base station operates an on-demand SSB.

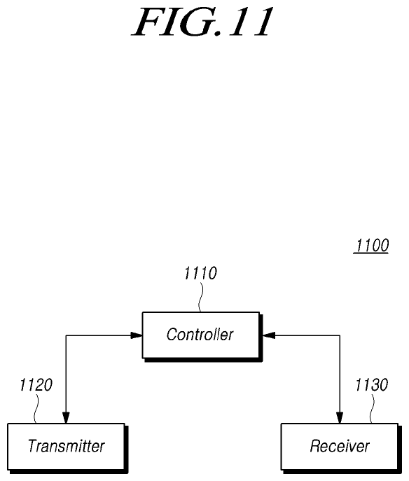

FIG. 11 is a block diagram illustrating a configuration of a base station 1100 according to another embodiment.

Referring to FIG. 11, a base station 1100 according to an embodiment include a transmitter 1120, a receiver 1130, and a controller 1110 configured to control operations of the transmitter and the receiver.

The controller 1110 controls overall operations of the base station 1100 according to a method of transmitting an on-demand synchronization signal in wireless communication required to perform the present invention described above.

The controller 1110 may transmit, to a UE, a higher layer message including configuration information for the OD-SSB. The higher layer message may be an RRC message for radio resource control between the base station and the UE.

According to an embodiment, the OD-SSB may be transmitted through a Secondary Cell (SCell), and the higher layer message may include a plurality of candidate configuration values applicable to the OD-SSB of the SCell. Specific parameters (e.g., frequency, period, subcarrier spacing, etc.) included in the configuration information and the plurality of candidate configuration values and frequency position settings related to a synchronization raster are substantially the same as described above with reference to FIG. 9, and thus a detailed description is omitted.

In addition, the controller 1110 may transmit, to the UE, a first MAC-CE indicating activation of the OD-SSB.

According to an embodiment, the first MAC-CE may indicate a predetermined configuration index to be applied to the SCell among the plurality of candidate configuration values. Accordingly, the controller 1110 may indicate a configuration value to be applied quickly by the UE by minimizing delay time without RRC connection reconfiguration.

Subsequently, the controller 1110 may transmit the OD-SSB based on the configuration information and the first MAC-CE.

The controller 1110 performs transmitting of the OD-SSB based on whether a parameter related to a number of transmissions of the OD-SSB is included in the configuration information.

According to an embodiment, when the parameter related to the number of transmissions is included in the configuration information, the transmitting of the OD-SSB may be deactivated after the OD-SSB is transmitted a number of times indicated by the parameter from an activation time indicated through the first MAC-CE. That is, when transmitting is completed a present number of times, the controller 1110 may perform an implicit deactivation procedure to stop the transmitting of the OD-SSB without additional control without a separate additional indication to the UE.

According to another embodiment, when the parameter related to the number of transmissions is not included in the configuration information, the transmitting of the OD-SSB may be maintained until a second MAC-CE or an additional higher layer message indicating deactivation of the OD-SSB is transmitted to the UE. That is, the controller 1110 may control to maintain a transmission state in the cell until an explicit deactivation indication is transmitted in a situation where a finite number of transmissions is not specified.

According to another embodiment, in an exceptional situation in which an explicit deactivation conflicts with a parameter related to a number of transmissions is configured, the controller 1110 may apply a priority control mechanism. Specifically, the transmitting of the OD-SSB may be stopped based on an indication of the second MAC-CE, or the transmitting of the OD-SSB may be maintained for the number of transmissions indicated by the parameter, when a second MAC-CE indicating deactivation of the OD-SSB is transmitted to the UE before the OD-SSB is transmitted the number of times indicated by the parameter.

According to the embodiments described above, by transmitting and receiving an on-demand synchronization signal in wireless communication, a synchronization signal and system information may be efficiently transmitted. In addition, efficient synchronization signal transmission management may be supported in an environment where a base station operates an on-demand SSB.

The above-described embodiments may be supported by standard documents disclosed in at least one of wireless access systems, which are IEEE 802, 3GPP, and 3GPP2. That is, steps, configurations, and parts among the present embodiments that are not described to clearly reveal the technical idea may be supported by the above-described standard documents. In addition, all terms disclosed in the present specification may be explained by the above-disclosed standard documents.

The above-described embodiments may be implemented through various means. For example, the present embodiments may be implemented by hardware, firmware, software, or a combination thereof.

In the case of implementation by hardware, the method according to the present embodiments may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, the method according to the present embodiments may be implemented in the form of a device, a procedure, a function, or the like, which performs the functions or operations described above. Software code may be stored in a memory unit and driven by a processor. The memory unit may be located inside or outside the processor and may exchange data with the processor by various already known means.

In addition, terms such as “system”, “processor”, “controller”, “component”, “module”, “interface”, “model”, or “unit” described above may generally refer to computer-related entity hardware, a combination of hardware and software, software, or software in execution. For example, the above-described components may be, but are not limited to, a process running on a processor, a processor, a controller, a control processor, an object, an execution thread, a program, and/or a computer. For example, both an application running on a controller or a processor and the controller or the processor may be components. One or more components may be within a process and/or execution thread, and the components may be located in one device (e.g., a system, a computing device, etc.) or distributed across two or more devices.

The above description is merely an illustration of the technical idea of the present disclosure, and various modifications and variations will be possible to those skilled in the art without departing from the essential characteristics of the technical idea of the present disclosure. In addition, the present embodiments are intended to explain rather than limit the technical idea of the present disclosure, and thus the scope of the technical idea of the present disclosure is not limited by these embodiments. The protection scope of the present disclosure should be interpreted by the following claims, and all technical ideas within the equivalent scope should be interpreted as being included in the scope of rights of the present disclosure.

What is claimed is:

1. A method of a user equipment (UE) for receiving an On-Demand Synchronization Signal Block (OD-SSB) in wireless communication, the method comprising:
receiving, from a base station, a higher layer message including configuration information for the OD-SSB;
receiving, from the base station, a first Medium Access Control-Control Element (MAC-CE) indicating activation of the OD-SSB; and
receiving the OD-SSB based on the configuration information and the first MAC-CE,
wherein the receiving of the OD-SSB is performed depending on whether a parameter related to a number of transmissions of the OD-SSB is included in the configuration information.

2. The method of claim 1, wherein when the parameter related to the number of transmissions is included in the configuration information, the receiving of the OD-SSB is deactivated after the OD-SSB is received a number of times indicated by the parameter from an activation time indicated through the first MAC-CE.

3. The method of claim 1, wherein when the parameter related to the number of transmissions is not included in the configuration information, the receiving of the OD-SSB is maintained until a second MAC-CE or an additional higher layer message indicating deactivation of the OD-SSB is received from the base station.

4. The method of claim 1, wherein the OD-SSB is received through a Secondary Cell (SCell),
wherein the higher layer message includes a plurality of candidate configuration values applicable to the OD-SSB of the SCell, and
wherein the first MAC-CE indicates a predetermined configuration index to be applied to the SCell among the plurality of candidate configuration values.

5. The method of claim 2, wherein when a second MAC-CE indicating deactivation of the OD-SSB is received from the base station before the OD-SSB is received the number of times indicated by the parameter, the receiving of the OD-SSB is stopped based on an indication of the second MAC-CE.

6. A method of a base station for transmitting an On-Demand Synchronization Signal Block (OD-SSB) in wireless communication, the method comprising:
transmitting, to a User Equipment (UE), a higher layer message including configuration information for the OD-SSB;
transmitting, to the UE, a first Medium Access Control-Control Element (MAC-CE) indicating activation of the OD-SSB; and
transmitting the OD-SSB based on the configuration information and the first MAC-CE,
wherein the transmitting of the OD-SSB is performed depending on whether a parameter related to a number of transmissions of the OD-SSB is included in the configuration information.

7. The method of claim 6, wherein when the parameter related to the number of transmissions is included in the configuration information, the transmitting of the OD-SSB is deactivated after the OD-SSB is transmitted a number of times indicated by the parameter from an activation time indicated through the first MAC-CE.

8. The method of claim 6, wherein when the parameter related to the number of transmissions is not included in the configuration information, the transmitting of the OD-SSB is maintained until a second MAC-CE or an additional higher layer message indicating deactivation of the OD-SSB is transmitted to the UE.

9. The method of claim 6, wherein the OD-SSB is transmitted through a Secondary Cell (SCell),
wherein the higher layer message includes a plurality of candidate configuration values applicable to the OD-SSB of the SCell, and
wherein the first MAC-CE indicates a predetermined configuration index to be applied to the SCell among the plurality of candidate configuration values.

10. The method of claim 7, wherein when a second MAC-CE indicating deactivation of the OD-SSB is transmitted to the UE before the OD-SSB is transmitted the number of times indicated by the parameter, the transmitting of the OD-SSB is stopped based on an indication of the second MAC-CE.

11. A User Equipment (UE) receiving an On-Demand Synchronization Signal Block (OD-SSB) in wireless communication, the UE comprising:
a transmitter;
a receiver; and
a controller configured to control operations of the transmitter and the receiver,
wherein the controller is configured to:
receive, from a base station, a higher layer message including configuration information for the OD-SSB;
receive, from the base station, a first Medium Access Control-Control Element (MAC-CE) indicating activation of the OD-SSB; and
receive the OD-SSB based on the configuration information and the first MAC-CE, and
wherein the receiving of the OD-SSB is performed depending on whether a parameter related to a number of transmissions of the OD-SSB is included in the configuration information.

12. The UE of claim 11, wherein when the parameter related to the number of transmissions is included in the configuration information, the receiving of the OD-SSB is deactivated after the OD-SSB is received a number of times indicated by the parameter from an activation time indicated through the first MAC-CE.

13. The UE of claim 11, wherein when the parameter related to the number of transmissions is not included in the configuration information, the receiving of the OD-SSB is maintained until a second MAC-CE or an additional higher layer message indicating deactivation of the OD-SSB is received from the base station.

14. The UE of claim 11, wherein the OD-SSB is received through a Secondary Cell (SCell),
wherein the higher layer message includes a plurality of candidate configuration values applicable to the OD-SSB of the SCell, and
wherein the first MAC-CE indicates a predetermined configuration index to be applied to the SCell among the plurality of candidate configuration values.

15. The UE of claim 12, wherein when a second MAC-CE indicating deactivation of the OD-SSB is received from the base station before the OD-SSB is received the number of times indicated by the parameter, the receiving of the OD-SSB is stopped based on an indication of the second MAC-CE.
